(19) United States
(12) Patent Application Publication
(10) Pub. No.: US 2025/0014138 A1
(43) Pub. Date: Jan. 9, 2025

(54) DISPLAY CONTROL DEVICE, IMAGE FILE MANAGEMENT DEVICE, DISPLAY CONTROL METHOD, AND DISPLAY CONTROL PROGRAM

(71) Applicant: FUJIFILM Corporation, Tokyo (JP)

(72) Inventors: Yuta ABE, Saitama-shi (JP); Tetsuro ASHIDA, Saitama-shi (JP); Tomoharu SHIMADA, Saitama-shi (JP); Morito NISEKI, Saitama-shi (JP)

(73) Assignee: FUJIFILM Corporation, Tokyo (JP)

(21) Appl. No.: 18/893,983

(22) Filed: Sep. 24, 2024

Related U.S. Application Data
(63) Continuation of application No. PCT/JP2023/011896, filed on Mar. 24, 2023.

(30) Foreign Application Priority Data
Mar. 31, 2022 (JP) 2022-059048

(51) Int. Cl. G06T 1/00; G06V 10/75; G06V 10/764; G06V 20/50; G11B 27/10

(52) U.S. Cl. CPC G06T 1/0007; G06V 10/751; G06V 10/764; G06V 20/50; G11B 27/10

(57) ABSTRACT

A display control device includes: a processor; and a memory. The processor is configured to: acquire a plurality of image data; acquire area information which is information on an area related to the image data; select first image data based on a first criterion from an image data group which is a set of the image data corresponding to the same area information; and perform control of displaying, on a display, at least one image data in the image data group as second image data based on the first image data.

### CROSS-REFERENCE TO RELATED APPLICATIONS

This is a continuation of International Application No. PCT/JP2023/011896 filed on Mar. 24, 2023, and claims priority from Japanese Patent Application No. 2022-059048 filed on Mar. 31, 2022, the entire content of which is incorporated herein by reference.

### BACKGROUND OF THE INVENTION

### 1. Field of the Invention

The present invention relates to a display control device, an image file management device, a display control method, and a computer-readable storage medium that stores a display control program.

### 2. Description of the Related Art

JP2004-289436A discloses an imaging system comprising an imaging apparatus that is movably installed and includes an input unit that receives input of user information for specifying a user who performs imaging using the imaging apparatus, and an imaging apparatus communication unit that transmits image data acquired by the imaging to the outside in association with the user information, an image server that stores the image data acquired by the imaging apparatus in association with the user information of the user who has performed the imaging, and a communication device that receives the image data from the imaging apparatus and transmits the image data to the image server.

JP2019-114952A discloses a self-photographing system. In this system, a network camera transmits image information, a beacon transmits beacon information, a mobile terminal receives the beacon information, generates tracking data corresponding to the beacon information based on a reception situation of the beacon information, and transmits the generated tracking data, and a server receives the image information transmitted from the network camera and the tracking data transmitted from the mobile terminal, and specifies an image of a part related to a date and time of entry and exit of a subject from an image of the image information based on the image information and the tracking data.

JP2002-281418A discloses an imaging apparatus comprising an imaging unit that images a subject, an imaging place information acquisition unit that acquires imaging place information related to an imaging place where imaging is performed, a data storage unit that stores an image captured by the imaging unit and the imaging place information acquired by the imaging place information acquisition unit in association with each other, an area reception unit that receives designation of an area from a user, and an in-area image output unit that reads out an image captured in the area received by the area reception unit from the data storage unit by referring to the imaging place information stored in the data storage unit and outputs the image.

### SUMMARY OF THE INVENTION

An object of the present invention is to provide a novel display control device, image file management device, display control method, and computer-readable storage medium that stores a display control program.

According to an aspect of the present invention, there is provided a display control device comprising: a processor; and a memory, in which the processor is configured to: acquire a plurality of image data; acquire area information which is information on an area related to the image data; select first image data based on a first criterion from an image data group which is a set of the image data corresponding to the same area information; and perform control of displaying, on a display, at least one image data in the image data group as second image data based on the first image data.

According to an aspect of the present invention, there is provided a display control device comprising: a processor; and a memory, in which the processor is configured to: acquire a plurality of image data; perform control of displaying first image data among the plurality of image data on a display; and perform control of displaying at least one image data among the plurality of image data as second image data on the display based on a state of a subject included in the first image data.

According to an aspect of the present invention, there is provided an image file management device comprising: a processor; and a memory, in which the processor is configured to: acquire a plurality of image files; acquire area information which is information on an area related to the image files; and perform control of classifying the plurality of image files based on the area information.

According to an aspect of the present invention, there is provided a display control method comprising: acquiring a plurality of image data; acquiring area information which is information on an area related to the image data; selecting first image data based on a first criterion from an image data group which is a set of the image data corresponding to the same area information; and performing control of displaying, on a display, at least one image data in the image data group as second image data based on the first image data.

According to an aspect of the present invention, there is provided a non-transitory computer-readable storage medium that stores a display control program for causing a processor to execute steps comprising: acquiring a plurality of image data; acquiring area information which is information on an area related to the image data; selecting first image data based on a first criterion from an image data group which is a set of the image data corresponding to the same area information; and performing control of displaying, on a display, at least one image data in the image data group as second image data based on the first image data.

According to the present invention, it is possible to provide a display control device, an image file management device, a display control method, and a computer-readable storage medium that stores a display control program.

### BRIEF DESCRIPTION OF THE DRAWINGS

FIG. 1 is a diagram schematically showing a configuration of an image management system 100 including a display control device 40 which is one embodiment of a display control device or an image file management device according to an embodiment of the present invention.

FIG. 2 is a schematic diagram showing an example of an acquired image file group 50.

FIG. 3 is a schematic diagram showing an example in which the acquired image file group 50 is classified.

FIG. 4 is a diagram showing examples of image file groups G1, G2, and G3 generated by selection processing.

FIG. 5 is a diagram schematically showing a display region 44R of a display 44.

FIG. 6 is a schematic diagram showing a display example of the display 44.

FIG. 7 is a schematic diagram showing a display example of the display 44.

FIG. 8 is a diagram showing modification examples of the image file groups G1, G2, and G3 generated by the selection processing.

FIG. 9 is a schematic diagram showing a display example of the display 44.

### DESCRIPTION OF THE PREFERRED EMBODIMENTS

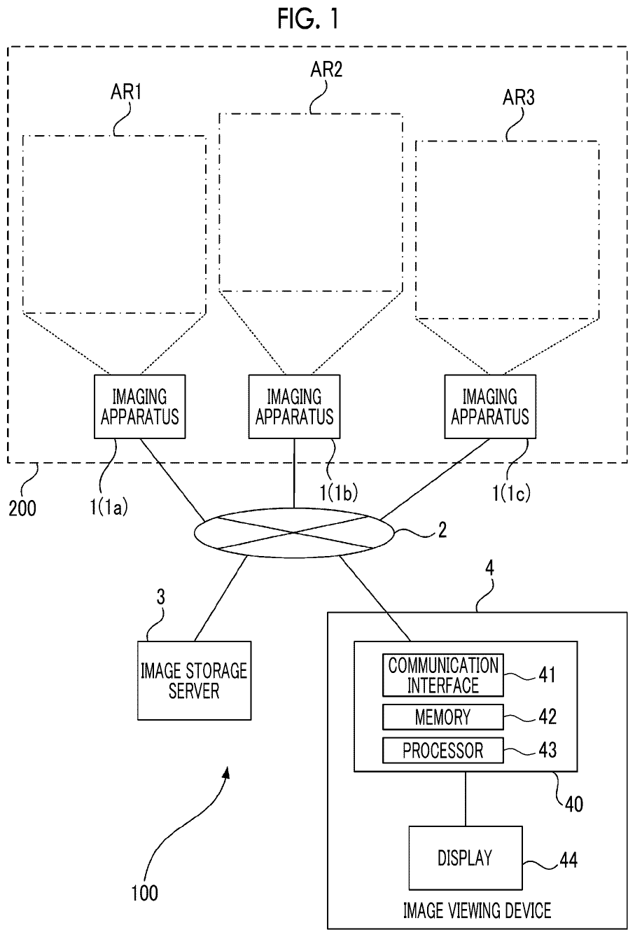

FIG. 1 is a diagram showing a schematic configuration of an image management system 100 including a display control device 40 which is one embodiment of a display control device or an image file management device according to the present invention. The image management system 100 comprises one or a plurality of imaging apparatuses 1 (in the example of FIG. 1, three imaging apparatuses 1a, 1b, and 1c), a network 2 such as the Internet or a local area network (LAN), an image storage server 3, and an image viewing device 4. The imaging apparatus 1 is disposed in, for example, an event venue such as an amusement facility, a theme park, or a wedding hall, or a facility such as a studio. The three imaging apparatuses 1 are disposed at different positions in the facility and are configured to image a user or the like who uses the facility from different directions.

In the example of FIG. 1, three imaging apparatuses 1 are installed in an amusement facility 200. In the amusement facility 200, an area AR1 for performing a first amusement, an area AR2 for performing a second amusement, and an area AR3 for performing a third amusement are set by a manager. The imaging apparatus 1 is installed corresponding to each of the three areas. The imaging apparatus 1a is disposed to be able to image a subject such as a person or an animal in the area AR1. The imaging apparatus 1b is disposed to be able to image a subject such as a person or an animal in the area AR2. The imaging apparatus 1c is disposed to be able to image a subject such as a person or an animal in the area AR3. A plurality of the imaging apparatuses 1 may be provided for one area by changing disposition or an imaging direction.

The imaging apparatus 1 includes an imaging element, an image processing circuit that processes a captured image signal obtained by imaging a subject with the imaging element to generate image data, and a communication interface that is connectable to the network 2. The imaging apparatus 1 is configured with, for example, a digital camera or a smartphone. The image data generated by the imaging apparatus 1 is also referred to as image data captured by the imaging apparatus 1. The imaging apparatus 1 transmits an image file including the generated image data and additional information added to the image data to the image storage server 3 via the network 2. The additional information of the image data includes a generation time point (synonymous with a capturing time point) of the image data and identification information of the imaging apparatus 1 that has generated the image data. The additional information may include information on an area imaged by the imaging apparatus 1 or position information (information such as latitude and longitude) of the imaging apparatus 1. The imaging apparatus 1 automatically and continuously executes imaging or automatically executes imaging at a predetermined interval in accordance with control of a control device (not shown). Therefore, a large amount of image data is sequentially uploaded to the image storage server 3.

The imaging apparatus 1 may perform still image capturing to generate image data of a still image or may perform moving image capturing to generate moving image data that is a set of the image data of the still image. That is, the image file may include the image data of the still image and the additional information, or may include the moving image data and the additional information.

The image storage server 3 comprises a processor, a communication interface that can be connected to the network 2, and a storage device such as a solid state drive (SSD) or a hard disk drive (HDD). This storage device may be a network storage device connected to the network 2. The processor of the image storage server 3 acquires the image file transmitted from the imaging apparatus 1 and stores the acquired image file in the storage device.

The image viewing device 4 is a device that views a part or entirety of all the image files stored in the storage device of the image storage server 3. The image viewing device 4 comprises a display 44 such as a liquid crystal display panel or an organic electro-luminescence (EL) display panel, and a display control device 40 that performs control to display the image data included in the image file on the display 44. Displaying the image data means displaying an image based on the image data.

The display 44 is equipped with a touch panel, and the user can perform various operations on a display region with a finger or the like. The display 44 does not have to include a touch panel. In this case, the display 44 need only be operated by using an operation device, such as a mouse, connected to the display control device 40.

The display control device 40 comprises a communication interface 41 for connection to the network 2, a memory 42 including a random access memory (RAM) and a read only memory (ROM), and a processor 43.

Each of the processor of the image storage server 3 and the processor 43 of the display control device 40 is a central processing unit (CPU) which is a general-purpose processor that executes software (program including a display control program) to perform various functions, a programmable logic device (PLD) which is a processor whose circuit configuration is changeable after manufacturing such as a field programmable gate array (FPGA), a dedicated electric circuit which is a processor having a circuit configuration exclusively designed to execute specific processing such as an application specific integrated circuit (ASIC), or the like. Each of the processor of the image storage server 3 and the processor 43 of the display control device 40 may be configured with one processor, or may be configured with a combination of two or more processors of the same type or different types (for example, a combination of a plurality of FPGAs or a combination of a CPU and an FPGA). More specifically, a hardware structure of the processor of the image storage server 3 and the processor 43 of the display control device 40 is an electric circuit (circuitry) in which circuit elements, such as semiconductor elements, are combined.

Next, a process performed by the processor 43 of the display control device 40 will be described.

The processor 43 acquires an unacquired image file among the image files stored in the storage device of the image storage server 3 via the network 2 each time a predetermined time elapses or at a specific timing such as a case where the number of the image files newly stored in the storage device of the image storage server 3 reaches a predetermined value.

### (Area Association Processing)

The processor 43 acquires area information, which is information on an area related to image data included in each image file, based on all the image files (hereinafter, referred to as an acquired image file group 50) acquired from the image storage server 3. The information on the area related to the image data is information for specifying an area which is an imaging target of the imaging apparatus 1 that has generated (captured) the image data. In a case where the processor 43 acquires the area information related to the image data of each image file, the processor 43 performs processing of associating the area information with the image data.

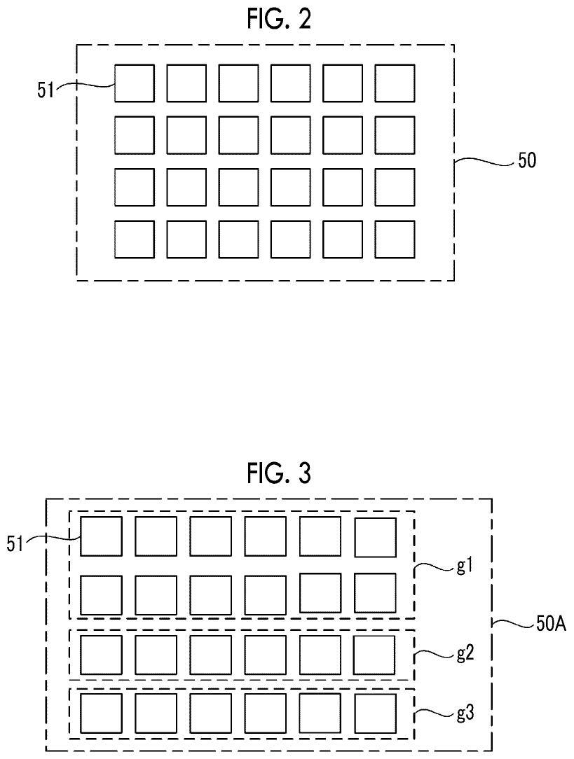

FIG. 2 is a schematic diagram showing an example of the acquired image file group 50. A rectangle included in the acquired image file group 50 indicates image data 51 included in each image file of the acquired image file group 50. For example, in a case where the processor 43 detects a feature point, such as a pattern, a character, or an object, representing a feature of the area AR1 from one image data 51 shown in FIG. 2, the processor 43 determines that an area in which the image data 51 is captured is the area AR1 and associates area information for specifying the area AR1 with the image data 51. Similarly, in a case where the processor 43 detects a feature point representing a feature of the area AR2 from the image data 51, the processor 43 determines that an area in which the image data 51 is captured is the area AR2, and associates area information for specifying the area AR2 with the image data 51. Similarly, in a case where the processor 43 detects a feature point representing a feature of the area AR3 from the image data 51, the processor 43 determines that an area in which the image data 51 is captured is the area AR3, and associates area information for specifying the area AR3 with the image data 51. The processor 43 performs such association processing for all the image data 51 included in the acquired image file group 50.

The area information related to the image data 51 can also be acquired by a method other than analyzing the image data 51. For example, in a case where the area information is included in the additional information of the image file, the processor 43 only needs to acquire the area information from the image file and determine which area the image data 51 is captured in. In this case, since the image data and the area information have already been associated with each other, the association processing is not necessary. In addition, in a case where positional information is included in the additional information of the image file, the processor 43 only needs to determine an area in which the image data 51 is captured based on the positional information and associate area information for specifying the determined area with the image data 51. In addition, the area information may be acquired by analyzing the image data 51 of only the image file in which the area information and the positional information are not included in the additional information of the image file. In a case where the area information cannot be acquired by any method, for example, additional information indicating that the area information is unknown may be added to the image file to be distinguished from the image file group for which the area information can be acquired. The input of the area information may be received from the user for the acquired image file group of which the area information is unknown. Hereinafter, it is assumed that the area information is associated with each image data 51 of the acquired image file group 50 shown in FIG. 2 to generate an acquired image file group 50A.

### (Classification Processing)

The processor 43 executes classification processing of classifying the acquired image file group 50A based on the area information associated with each image data included in the acquired image file group 50A. FIG. 3 is a schematic diagram showing an example in which the acquired image file group 50A is classified. In the example of FIG. 3, the acquired image file group 50A is classified into an image file group g1 which is a set of image files including the image data 51 corresponding to the area information for specifying the area AR1, an image file group g2 which is a set of image files including the image data 51 corresponding to the area information for specifying the area AR2, and an image file group g3 which is a set of image files including the image data 51 corresponding to the area information for specifying the area AR3.

### (Selection Processing)

The processor 43 executes selection processing of selecting image data (hereinafter, also referred to as third image data) based on a second criterion from the image data included in each image file group obtained by the classification processing. Specifically, the processor 43 selects the image data 51 satisfying the second criterion among the image data 51 of the image file group g1 shown in FIG. 3 as the third image data, and obtains an image file group G1 including the selected image data 51. In addition, the processor 43 selects the image data 51 satisfying the second criterion among the image data 51 of the image file group g2 shown in FIG. 3 as the third image data, and obtains an image file group G2 including the selected image data 51. In addition, the processor 43 selects the image data 51 satisfying the second criterion among the image data 51 of the image file group g3 shown in FIG. 3 as the third image data, and obtains an image file group G3 including the selected image data 51.

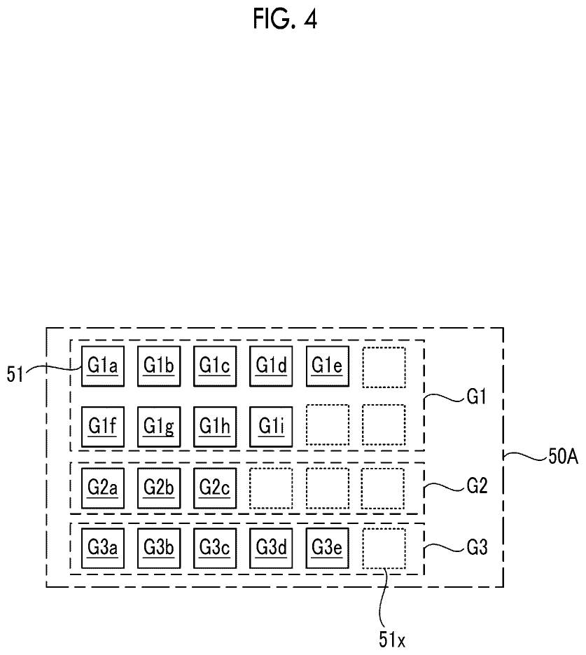

FIG. 4 is a diagram showing examples of the image file groups G1, G2, and G3 generated by the selection processing. Among the image data included in the acquired image file group 50A shown in FIG. 4, the image data (image data 51x) indicated by a broken line rectangle does not satisfy the second criterion and indicates the image data not selected by the processor 43.

In FIG. 4, nine image data 51 included in the image file group G1 are shown as image data G1a to image data G1i. Further, three image data 51 included in the image file group G2 are shown as image data G2a to image data G2c. Further, five image data 51 included in the image file group G3 are shown as image data G3a to image data G3c.

Either the selection processing or the classification processing may be executed first. That is, the processor 43 may generate the image file groups G1, G2, and G3 shown in FIG. 4 by selecting the image files including the image data 51 satisfying the second criterion from the acquired image file group 50 and classifying the selected plurality of image files based on the area information.

The second criterion is a requirement related to an image quality of the image data, and is specifically a requirement that the image quality is equal to or higher than an image quality threshold value. The second criterion is not limited to the requirement related to the image quality, and may be a requirement that a person or an animal is included in the image data, or that the image data is selected by a user of the image viewing device 4, or the like. The image quality being equal to or higher than the image quality threshold value means, for example, that evaluation of the image data is derived as a score, and the score is equal to or higher than a score threshold value. The score of the image data is derived based on, for example, an evaluation value of brightness, color, contrast, or the like, an evaluation value of sharpness of a person or an animal included in the image data, an evaluation value determined based on whether or not an eye of a person or an animal included in the image data is open, an evaluation value determined based on whether or not a position or a size of a person or an animal included in the image data satisfies a predetermined condition, an evaluation value determined based on a facial expression (degree of smiling) of a person or an animal included in the image data, an evaluation value determined based on whether or not a face orientation of a person or an animal included in the image data satisfies a predetermined condition, and the like. For example, a value obtained by adding these plurality of evaluation values need only be used as the score. One of these plurality of evaluation values may be used as it is as the score. In addition, the requirement of the second criterion may be determined by artificial intelligence. Subsequent requirements may be similarly determined by the artificial intelligence.

### (Display Processing)

The processor 43 performs control of selecting image data (hereinafter, also referred to as first image data) based on a first criterion from any of the image file groups shown in FIG. 4 and displaying the first image data on the display 44. The first criterion is a requirement that the image data is designated by the user, a requirement that the image data has the highest image quality, a requirement that the image data is randomly decided, a requirement that the image data includes a specific subject, a requirement that the image data is image data having the oldest capturing time point, or the like. The display 44 and the display control device 40 may be separate bodies. In addition, a relay device or the like may be provided between the display 44 and the display control device 40. The “control of displaying the image data on the display 44” performed by the processor 43 also includes control of displaying the image data on the display 44 via the relay device. For example, control of outputting the image data to the relay device in order for the relay device to perform control of displaying the image data on the display 44 is also included in the “control of displaying the image data on the display 44” performed by the processor 43.

Further, the processor 43 performs control of selecting at least one image data based on the first image data as second image data from the image file group to which the selected first image data belongs and displaying the second image data on the display 44. Hereinafter, selection of image data displayed on the display 44 means selection of the image data or an image file including the image data.

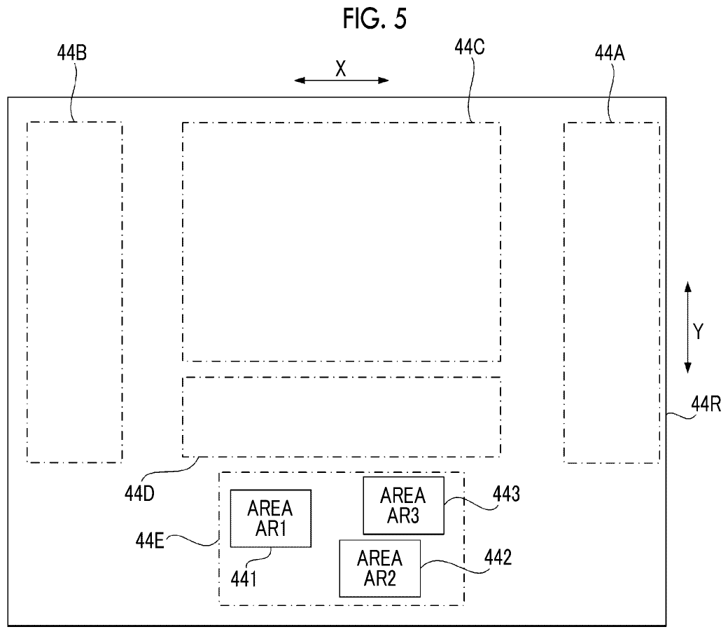

FIG. 5 is a diagram schematically showing a display region 44R of the display 44. The display region 44R has a rectangular shape in which a direction X is a longitudinal direction and a direction Y intersecting the direction X (in the example of FIG. 5, perpendicular to the direction X) is a lateral direction. In the display region 44R, a first region 44A that extends in the direction Y and is disposed on one end side in the direction X, a second region 44B that extends in the direction Y and is disposed on the other end side in the direction X, and a third region 44C, a fourth region 44D, and a fifth region 44E that are disposed between the first region 44A and the second region 44B are set.

The processor 43 performs control of displaying an area image showing the area information corresponding to each image file group shown in FIG. 4 in the fifth region 44E. In the example of FIG. 5, an area image 441 showing the area information corresponding to the image file group G1, an area image 442 showing the area information corresponding to the image file group G2, and an area image 443 showing the area information corresponding to the image file group G3 are displayed in the fifth region 44E.

In a case where any of the area image 441, the area image 442, or the area image 443 displayed in the fifth region 44E is selected, the processor 43 performs control of displaying the image data of the image file group corresponding to the selected area image in the first region 44A. FIG. 5 shows an example in which two area images can be selected at the same time. In a case where two of the area image 441, the area image 442, and the area image 443 displayed in the fifth region 44E are selected, the processor 43 performs control of displaying the image data of the image file group corresponding to the selected one area image in the first region 44A and displaying the image data of the image file group corresponding to the selected other area image in the second region 44B.

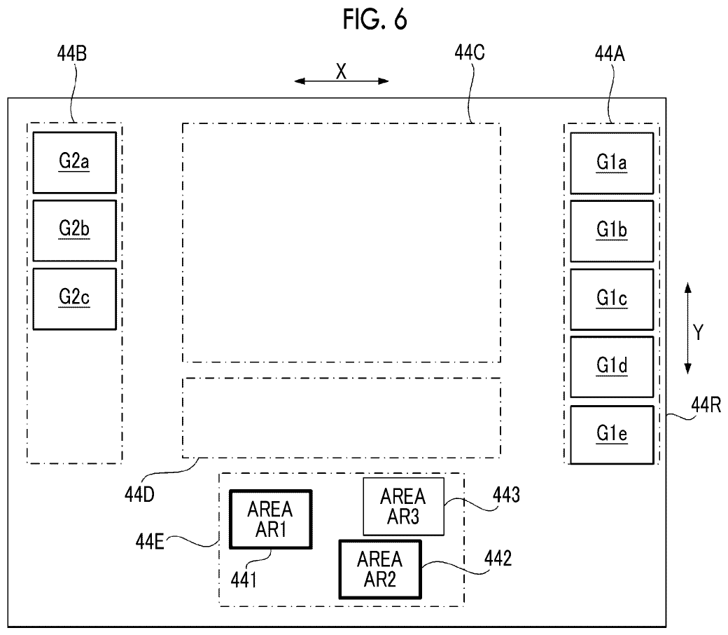

FIG. 6 shows a display example in a case where the area image 441 and the area image 442 are selected from a state shown in FIG. 5. In the example shown in FIG. 6, a part (image data G1a, image data G1b, image data G1c, image data G1d, and image data G1e) of nine image data 51 included in the image file group G1 is displayed in the first region 44A. Further, three image data 51 (image data G2a, image data G2b, and image data G2c) included in the image file group G2 are displayed in the second region 44B. In the example of FIG. 6, although all the image data of the image file group G1 are not displayed at once in the first region 44A, in such a case, all the image data of the image file group G1 need only be displayed by scroll display.

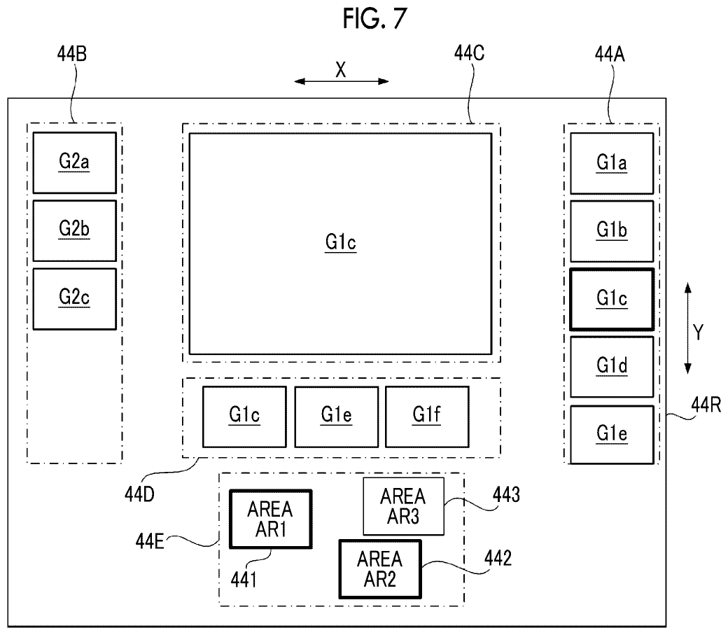

FIG. 7 shows a display example in a case where any one (here, the image data G1c) of the image data displayed in the first region 44A is selected by a user operation from a state of FIG. 6. In a case where the image data G1c is selected by the user operation, the processor 43 selects the image data G1c as first image data. The processor 43 may select, as the first image data, the image data of the image file group G1 displayed in the first region 44A, which has the oldest capturing time point or the highest image quality, or is randomly decided, without the user operation.

In a case where the processor 43 selects the image data G1c as the first image data, the processor 43 performs control of displaying the image data G1c in the third region 44C and the fourth region 44D. Further, the processor 43 performs control of selecting the image data G1e and the image data G1f as the second image data from the image file group G1 based on the image data G1c or additional information of the image data G1c and displaying the selected image data G1e and image data G1f in the fourth region 44D.

Specifically, the processor 43 selects at least one image data from the image file group G1 based on a capturing time point of the image data G1c. For example, the processor 43 selects, as the second image data, the image data G1e which is the image data captured at a first time point before the capturing time point of the image data G1c and the image data G1f which is the image data captured at a second time point before the first time point from the image data of the image file group G1. The processor 43 may select only one of the image data G1e and the image data G1f as the second image data.

In addition, the processor 43 may perform control of selecting the image data G1b, which is the image data captured at a time point after the capturing time point of the image data G1c, as the second image data, instead of any of the image data G1e or the image data G1f, and displaying the selected image data G1b in the fourth region 44D. In addition, the processor 43 may perform control of selecting the image data G1b, which is the image data captured at a time point after the capturing time point of the image data G1c, as the second image data, instead of the image data G1e and the image data G1f, and displaying the selected image data G1b in the fourth region 44D.

As shown in FIG. 7, it is preferable that the image data displayed in the fourth region 44D is displayed in order of the capturing time point. That is, it is preferable that the order of the image data displayed in the fourth region 44D is different depending on a combination of the selected images. The processor 43 performs control of displaying the image data G1c (=first image data) in the fourth region 44D, but this is not essential and may be omitted. That is, a form in which only the second image data is displayed in the fourth region 44D may be adopted. Further, the second image data displayed in the fourth region 44D may be three or more.

As described above, the processor 43 selects, as the second image data, at least one of the image data captured at the first time point before the capturing time point of the image data G1c (=first image data) or the image data captured at the time point after the capturing time point of the image data G1c from the image data of the image file group G1.

The processor 43 may select, as the second image data, at least one of the image data captured in a time slot before a time slot including the capturing time point of the image data G1c (=first image data) or the image data captured in a time slot after the time slot including the capturing time point of the image data G1c from the image data of the image file group G1.

As shown in FIG. 7, it is preferable that a display size of the image data displayed in the fourth region 44D is smaller than a display size of the image data displayed in the third region 44C. In addition, it is preferable that a display size of the image data displayed in the first region 44A and the second region 44B is smaller than the display size of the image data displayed in the third region 44C. In a state shown in FIG. 7, for example, in a case where the image data G1e is selected, the processor 43 preferably changes the image data to be displayed in the third region 44C from the image data G1c to the image data G1e.

### <Main Effect of Image Viewing Device 4>

According to the image viewing device 4, for example, only by performing an operation of selecting the image data of interest from the displayed image data of the image file group G1, the user can check the selected image data in a large display size in the third region 44C, and can check the image data captured before or after a capturing time point of the selected image data or captured in the same area at a timing before or after the capturing time point in the fourth region 44D. As a result, not only the image data of interest but also the image data having a temporal relationship with the image data of interest can be easily checked, and even in a case where the image data captured in the same area is present in a large amount, desired image data can be easily extracted. In addition, since the first image data (image data G1c) is displayed not only in the third region 44C but also in the fourth region 44D, even in a case where the image data to be displayed in the third region 44C is switched between the first image data and the second image data, a relevance between the first image data and the second image data can be always understood in the fourth region 44D, and the convenience can be improved.

<First Modification Example of Method of Selecting Second Image Data from Image File Group G1>

The processor 43 may select, as the second image data, image data captured on a day different from a day including the capturing time point of the first image data from the image data of the image file group G1.

For example, the processor 43 selects, as the second image data, image data including the same person as a person included in the first image data and/or image data having a similar composition to the first image data from the image data captured on a day different from a day including the capturing time point of the first image data. For example, in a case where the imaging apparatus 1 is fixed to image the same area, image data having a similar composition to the first image data can be acquired in a case where the same person is present at the same position on different days. In this way, the second image data that has been captured in the same environment in the past and includes the same person or composition as the first image data that the user is interested in can be displayed in the fourth region 44D. Accordingly, for example, in a case where the first image data includes a child, a growth degree of the child or the like can be easily checked by comparing the first image data with the second image data. For example, it is possible to check a difference in how child engage with specific equipment of the amusement facility 200.

<Second Modification Example of Method of Selecting Second Image Data from Image File Group G1>

The processor 43 may select the second image data based on a subject included in the first image data from the image data of the image file group G1. The “selecting the second image data based on a subject” includes selecting the second image data based on a state of the subject.

Specifically, the processor 43 may select the second image data based on a state of a person among subjects included in the first image data. For example, it is assumed that the first image data includes a person in a state in which both feet are separated from the ground. In this case, the processor 43 selects, as the second image data, at least one of image data including the person in a state immediately before both feet leave the ground or image data including the person in a state immediately after both feet land on the ground. In this way, by only performing the selection operation of the first image data, the user can check the second image data related to the state of the person included in the first image data, and can assist in the selection of the image data.

The processor 43 may select the second image data based on a state of an object other than the person from subjects included in the first image data. For example, it is assumed that the first image data includes a sporting instrument such as a skateboard or a snowboard in a state of being separated from the ground. In this case, the processor 43 selects, as the second image data, at least one of image data including the sporting instrument in a state immediately before the sporting instrument leaves the ground or image data including the sporting instrument in a state immediately after the sporting instrument lands on the ground. As a result, by only performing the selection operation of the first image data, the user can check the second image data related to the state of the object included in the first image data, and can assist in the selection of the image data.

<Third Modification Example of Method of Selecting Second Image Data from Image File Group G1>

The above-described “selecting the second image data based on a subject” includes selecting the second image data based on a numerical value related to the subject. The numerical value related to the subject includes the number of subjects included in the first image data or the number of types of the subjects included in the first image data.

Specifically, the processor 43 selects, as the second image data, image data including the same number of subjects as the number of subjects included in the first image data from the image data of the image file group G1. In this way, the user can check the second image data having the same number of subjects as the first image data and can assist in the selection of the image data without performing a special operation. The processor 43 may select, as the second image data, image data including the same number of types of subjects as the number of types of subjects included in the first image data from the image data of the image file group G1. Even with this, by only performing the selection operation of the first image data, the user can check the second image data in which the number of types of the subjects is the same as that of the first image data and can assist in the selection of the image data.

The processor 43 may select, as the second image data, image data including subjects of which the number is different from the number of subjects included in the first image data from the image data of the image file group G1. Similarly, the processor 43 may select, as the second image data, image data including subjects of which the number of types is different from the number of types of subjects included in the first image data from the image data of the image file group G1. In this way, by only performing the selection operation of the first image data, the user can check the second image data in which the number or type of the subjects is different from that of the first image data and can assist in the selection of the image data.

In the third modification example, it is assumed that the processor 43 selects, as the second image data, image data including the same number of subjects as the number of subjects included in the first image data from the image data of the image file group G1. In this case, there may be a situation in which the image data including the same number of the subjects as the number of the subjects included in the first image data is not present in the image data of the image file group G1. As described above, in a case where there is no candidate for the second image data, the processor 43 may perform processing of acquiring an image to be the candidate for the second image data. For example, the processor 43 may perform control of changing a setting (a focal length and an imaging direction) of the imaging apparatus 1 that has captured the first image data such that image data including the same number of subjects as the number of subjects included in the first image data is captured. For example, the processor 43 issues a command to a control device that controls the imaging apparatus 1 via the network 2, and the control device changes the setting of the imaging apparatus 1 according to the command. With this configuration, even in a case where there is no candidate for the second image data, the candidate can be obtained by changing the setting of the imaging apparatus 1, and the selection of the image data by the user can be assisted.

Similarly, it is assumed that the processor 43 selects, as the second image data, image data including the number of subjects different from the number of subjects included in the first image data from the image data of the image file group G1. In this case, there may be a situation in which the image data including the number of the subjects different from the number of the subjects included in the first image data is not present in the image data of the image file group G1. In such a situation, the processor 43 may perform control of changing the setting (a focal length and an imaging direction) of the imaging apparatus 1 that has captured the first image data such that image data including the number of subjects different from the number of subjects included in the first image data is captured.

Similarly, it is assumed that the processor 43 selects, as the second image data, image data including the same number of types of subjects as the number of types of subjects included in the first image data from the image data of the image file group G1. In this case, there may be a situation in which the image data including the same number of types of subjects as the number of types of subjects included in the first image data is not present in the image data of the image file group G1. In such a situation, the processor 43 may perform control of changing the setting (a focal length and an imaging direction) of the imaging apparatus 1 that has captured the first image data such that image data including the same number of types of subjects as the number of types of subjects included in the first image data is captured.

Similarly, it is assumed that the processor 43 selects, as the second image data, image data including the number of types of subjects different from the number of types of subjects included in the first image data from the image data of the image file group G1. In this case, there may be a situation in which the image data including the number of types of subjects different from the number of types of subjects included in the first image data is not present in the image data of the image file group G1. In such a situation, the processor 43 may perform control of changing the setting (a focal length and an imaging direction) of the imaging apparatus 1 that has captured the first image data such that image data including the number of types of subjects different from the number of types of subjects included in the first image data is captured.

<Fourth Modification Example of Method of Selecting Second Image Data from Image File Group G1>

The above-described “selecting the second image data based on a subject” includes selecting the second image data based on a position of the subject.

Specifically, the processor may select, as the second image data, image data in which a position (in other words, composition) of a subject is different from a position of a subject included in the first image data from the image data of the image file group G1. For example, it is assumed that the position of the subject included in the first image data is a center of the first image data. In this case, the processor 43 selects, as the second image data, image data including the subject and having the position of the subject at a right end of the first image data, and image data including the subject and having the position of the subject at a left end of the first image data. In this way, since the second image data obtained by capturing the subject included in the first image data selected by the user in a different composition can be displayed on the display 44, it is possible to assist the user in selecting the image data.

<Fifth Modification Example of Method of Selecting Second Image Data from Image File Group G1>

The processor 43 may select the second image data based on the imaging apparatus 1 that has captured the first image data from the image data of the image file group G1.

For example, it is assumed that there are three imaging apparatuses 1a as the imaging apparatuses 1a that image the area AR1. In this case, the processor 43 selects, as the second image data, image data captured by the imaging apparatus 1a different from the imaging apparatus 1a that has captured the first image data from the image data of the image file group G1.

For example, it is assumed that three imaging apparatuses 1a image a scene in which a child slides down a slide. It is assumed that the three imaging apparatuses 1a includes a first imaging apparatus that can image a state in which a child is present at a position highest on the slide (highest position), a second imaging apparatus that can image a state in which a child is present at a position intermediate on the slide, and a third imaging apparatus that can image a state in which a child is present at a position lowest on the slide (lowest position). Moreover, in a case where the first image data is captured by the second imaging apparatus, the processor 43 selects, as the second image data, image data captured by the first imaging apparatus and image data captured by the third imaging apparatus. In this way, it is possible to check a sequence of actions of a child going down the slide with the first image data and the second image data. In addition, a plurality of imaging apparatuses may be disposed such that a person or the like can be imaged before, during, and after the person or the like does something, such as before, during, and after a child slides down the slide, and a series of images thereof may be selected as the first image data and the second image data.

### Other Modification Examples

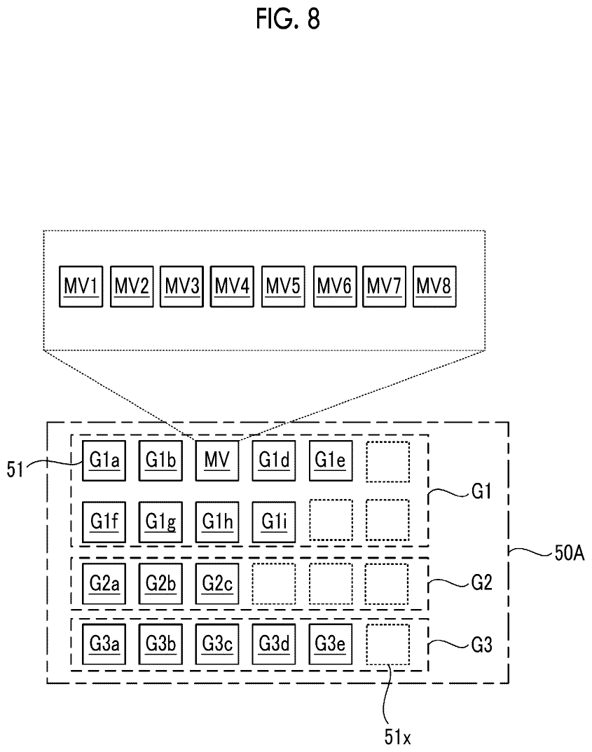

FIG. 8 is a diagram showing a modification example of the image file groups G1, G2, and G3 generated by the selection processing. FIG. 8 is the same as FIG. 4 except that the image data G1c in the image file group G1 is changed to moving image data MV. The moving image data MV is a set of a plurality of image data including image data MV1 to MV8. The image data MV1 to MV8 mean that the smaller the number of the reference is, the older the capturing time point is.

In a case where the moving image data MV is displayed in the first region 44A, the processor 43 performs control of extracting representative image data (for example, image data having the oldest capturing time point) from the plurality of image data composing the moving image data MV and display the extracted representative image data.

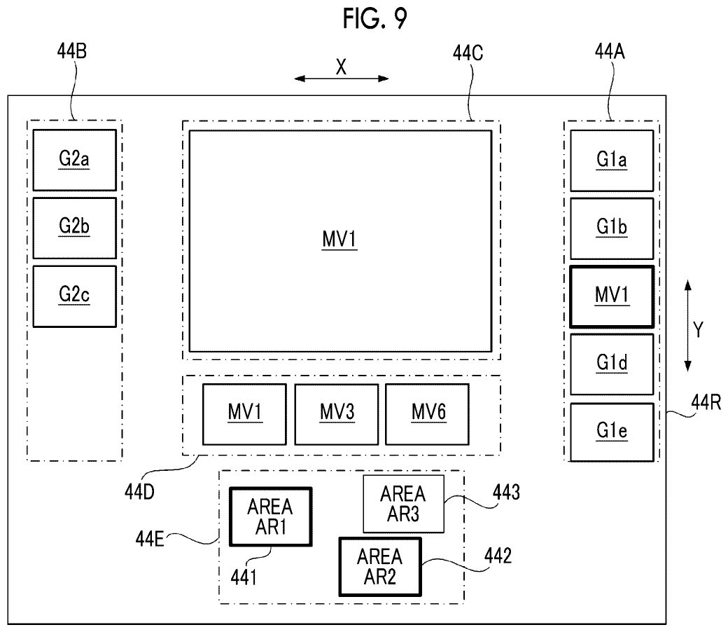

For example, as shown in FIG. 9, the processor 43 performs control such that the image data MV1 is displayed in the first region 44A as a representative of the moving image data MV. In this state, in a case where the image data MV1 is selected by the user, the processor 43 selects the image data MV1 as the first image data, and selects the second image data from the image data composing the moving image data MV including the image data MV1. As a method of selecting the second image data here, for example, a method of selecting the second image data based on a capturing time point of the first image data may be adopted, or a method of selecting the second image data based on a subject included in the first image data may be adopted. FIG. 9 shows an example in which the image data MV3 and the image data MV6 are selected as the second image data. In a case where the processor 43 selects the image data MV1 as the first image data, and selects each of the image data MV3 and the image data MV6 as the second image data, the processor 43 divides the moving image data MV into three pieces of data, that is, first moving image data composed of the image data from the image data MV1 to the image data MV2, second moving image data composed of the image data from the image data MV3 to the image data MV5, and third moving image data composed of the image data from the image data MV6 to the image data MV8, and manages the three pieces of data.

In a state shown in FIG. 9, in a case where the processor 43 detects an operation of reproducing a moving image for the image data MV1 displayed in the third region 44C or the fourth region 44D (for example, clicking on the image data MV1), the processor 43 performs control of reproducing the moving image data MV from the beginning (image data having the oldest capturing time point) in the third region 44C. The reproduction of the moving image data refers to displaying the image data composing the moving image data in order from the image data having the oldest capturing time point. In a case where the processor 43 detects an operation of reproducing a moving image for the image data MV3 displayed in the fourth region 44D, the processor 43 performs control of reproducing a portion of the moving image data MV from the capturing time point of the image data MV3 in the third region 44C. In a case where the processor 43 detects an operation of reproducing a moving image for the image data MV6 displayed in the fourth region 44D, the processor 43 performs control of reproducing a portion of the moving image data MV from the capturing time point of the image data MV6 in the third region 44C.

As described above, in a case where a part of the moving image data MV is selected as the first image data, the processor 43 selects the second image data from the image data included in the moving image data MV. Therefore, the user can check the image data included in the moving image data without reproducing all the moving image data, and the viewability of the image data can be improved. In addition, the processor 43 controls moving images corresponding to different time slots of the same moving image data MV (a moving image to be reproduced from the beginning, a moving image to be reproduced from the capturing time point of the image data MV3, and a moving image to be reproduced from the capturing time point of the image data MV6) to be reproduced. As a result, for example, even in a case of a long moving image, the content thereof can be efficiently viewed. The moving image data may be reproduced in the fourth region 44D. For example, in a case where a cursor is superimposed on the image data MV1 in the fourth region 44D by an operation of a mouse or the like, the image data MV1 on which the cursor is superimposed may be reproduced as a moving image. Similarly, the image data MV3 and the image data MV6 in the fourth region 44D may also be reproduced as the moving images in a case where the cursor is superimposed. In this case, the time slots of the moving images reproduced from the first image data and the second image data may be completely separated. In the example of FIG. 9, for example, the moving image reproduced from the image data MV1 may be a moving image from the image data MV1 to the image data MV2, the moving image reproduced from the image data MV3 may be a moving image from the image data MV3 to the image data MV5, and the moving image reproduced from the image data MV6 may be a moving image from the image data MV6 to the image data MV8. In this way, the moving image data MV can be viewed without duplication only by moving the cursor sequentially from the image data MV1 to the image data MV6 in the fourth region 44D.

In the example shown in FIG. 4, the number of the image data included in each of the image file group G1, the image file group G2, and the image file group G3 is different. The processor 43 may perform control such that a difference in the number of the image data included in each image file group is equal to or less than a threshold value (ideally, zero, that is, the number of the image data included in each image file group is the same).

For example, the processor 43 changes the second criterion used to obtain the image file groups G1, G2, and G3 from each of the image file groups g1, g2, and g3 shown in FIG. 3 for each of the image file groups g1, g2, and g3 to make a difference in the number of the image data included in the image file groups G1, G2, and G3 equal to or less than the threshold value. Alternatively, settings of the imaging apparatuses 1a, 1b, and 1c are changed such that the difference in the number of the image data included in the image file groups G1, G2, and G3 is equal to or smaller than the threshold value without changing the second criterion.

In this way, the number of the image data that can be displayed in the first region 44A and the second region 44B shown in FIG. 7 can be made to substantially match, and the image data can be viewed without bias for each area of the amusement facility 200.

In the image management system 100 described above, a part of processing executed by the processor 43 may be executed by the processor of the image storage server 3. For example, the processor of the image storage server 3 may perform at least one of the selection processing or the classification processing. In this case, the processor of the image storage server 3 and the processor 43 constitute a processor of the display control device or the image file management device.

As described above, at least the following matters are described in the present specification. Although corresponding constituents and the like in the embodiment described above are shown in parentheses, the present invention is not limited thereto.

(1)

A display control device comprising: a processor (processor 43); and a memory (memory 42), in which the processor is configured to: acquire a plurality of image data (acquired image file group 50); acquire area information which is information on an area related to the image data; select first image data (image data G1c in the example of FIG. 7) based on a first criterion from an image data group (image file group G1) which is a set of the image data corresponding to the same area information; and perform control of displaying, on a display (display 44), at least one image data (image data G1e and G1f in the example of FIG. 7) in the image data group as second image data based on the first image data.

(2)

The display control device according to (1), in which the processor is configured to select third image data (each image data 51 in FIG. 4) based on a second criterion from the plurality of image data, and the image data group is a set (image file group G1) of the third image data corresponding to the same area information.

(3)

The display control device according to (1) or (2), in which the processor is configured to select the second image data based on a capturing time point of the first image data.

(4)

The display control device according to any one of (1) to (3), in which the processor is configured to select at least one of the image data captured before a capturing time point of the first image data or the image data captured after the capturing time point of the first image data as the second image data.

(5)

The display control device according to (4), in which the processor is configured to select the image data captured at a first time point before the capturing time point of the first image data and the image data captured at a second time point before the first time point as the second image data.

(6)

The display control device according to any one of (1) to (3), in which the processor is configured to select the image data captured on a day different from a day including a capturing time point of the first image data as the second image data.

(7)

The display control device according to (1) or (2), in which the processor is configured to select the second image data based on a subject included in the first image data.

(8)

The display control device according to (1), (2), or (7), in which the processor is configured to select the second image data based on a state of a subject included in the first image data.

(9)

The display control device according to (1), (2), (7), or (8), in which the processor is configured to select the second image data based on a state of a person among subjects included in the first image data.

(10)

The display control device according to (1), (2), (7), or (8), in which the processor is configured to select the second image data based on a state of an object other than a person among subjects included in the first image data.

(11)

The display control device according to (1), (2), or (7), in which the processor is configured to select the second image data based on a numerical value related to a subject included in the first image data.

(12)

The display control device according to (1), (2), (7), or (11), in which the processor is configured to select the image data including the same number of subjects as the number of subjects included in the first image data as the second image data.

(13)

The display control device according to (1), (2), (7), or (11), in which the processor is configured to select the image data including the number of subjects different from the number of subjects included in the first image data as the second image data.

(14)

The display control device according to any one of (11) to (13), in which the plurality of image data are generated by an imaging apparatus (imaging apparatus 1), and the processor is configured to perform control such that the imaging apparatus generates image data including subjects whose number is based on the number of subjects included in the first image data, based on the number of the subjects included in the first image data.

(15)

The display control device according to (1), (2), or (7), in which the processor is configured to select the second image data based on a position of a subject included in the first image data.

(16)

The display control device according to (1), (2), (7), or (15), in which the processor is configured to select the image data including a subject of which a position is different from a position of a subject included in the first image data as the second image data.

(17)

The display control device according to (1) or (2), in which the plurality of image data are generated by a plurality of imaging apparatuses (imaging apparatuses 1), and the processor is configured to select the second image data based on an imaging apparatus that has captured the first image data.

(18)

The display control device according to (17), in which the processor is configured to select the image data captured by an imaging apparatus different from the imaging apparatus that has captured the first image data as the second image data.

(19)

The display control device according to any one of (1) to (18), in which the plurality of image data include moving image data (moving image data MV), the processor is configured to select third image data (each image data 51 in FIG. 4) based on a second criterion from the plurality of image data, the image data group is a set (image file group G1) of the third image data corresponding to the same area information, and the processor is further configured to, in a case where the third image data (in the example of FIG. 9, image data MV1) composing the moving image data is selected as the first image data, select image data (in the example of FIG. 9, image data MV3 and MV6) included in the moving image data as the second image data.

(20)

The display control device according to (19), in which the processor is configured to perform control of reproducing moving image data including the first image data and moving image data including the second image data.

(21)

The display control device according to (20), in which the processor is configured to perform control of reproducing a portion of the moving image data from a capturing time point of the second image data in a case where the second image data is selected, and reproducing the moving image data from a beginning in a case where the first image data is selected.

(22)

The display control device according to any one of (1) to (21), in which the processor is configured to select third image data (each image data 51 in FIG. 4) based on a second criterion from the plurality of image data, the image data group is a set (image file groups G1, G2, and G3) of the third image data corresponding to the same area information, and the processor is configured to: perform control of displaying, on the display, the first image data (image data G1c displayed in the third region 44C in FIG. 7), the second image data (image data G1e and G1f displayed in the fourth region 44D in FIG. 7), and the third image data (image data displayed in the first region 44A in FIG. 7) included in any of a plurality of the image data groups corresponding to different pieces of the area information; and perform control of making a difference in the number of the third image data displayed on the display equal to or less than a threshold value for each image data group.

(23)

The display control device according to any one of (1) to (21), in which the processor is configured to select third image data (each image data 51 in FIG. 4) based on a second criterion from the plurality of image data, the image data group is a set (image file groups G1, G2, and G3) of the third image data corresponding to the same area information, and the processor is configured to perform control of making a difference between the number of the third image data included in the image data group (image file group G1) corresponding to first area information and the number of the third image data included in the image data group (image file group G2) corresponding to second area information equal to or less than a threshold value.

(24)

The display control device according to (23), in which the processor is configured to: select the third image data based on a third criterion (second criterion) from the image data group (image file group g1) corresponding to the first area information; select the third image data based on a fourth criterion (second criterion) from the image data group (image file group g2) corresponding to the second area information; and perform control of making the difference equal to or less than the threshold value by changing one or both of the third criterion and the fourth criterion.

(25)

The display control device according to any one of (1) to (24), in which the processor is configured to perform control of displaying the first image data on the display.

(26)

A display control device comprising: a processor (processor 43); and a memory (memory 42), in which the processor is configured to: acquire a plurality of image data (acquired image file group 50); perform control of displaying first image data (image data G1c in FIG. 7) among the plurality of image data on a display (display 44); and perform control of displaying at least one image data (image data G1e and G1f in FIG. 7) among the plurality of image data as second image data on the display based on a state of a subject included in the first image data.

(27)

An image file management device comprising: a processor (processor 43); and a memory (memory 42), in which the processor is configured to: acquire a plurality of image files (acquired image file group 50); acquire area information which is information on an area related to the image files; and perform control of classifying the plurality of image files based on the area information (into image file groups g1, g2, and g3).

(28)

A display control method comprising: acquiring a plurality of image data (acquired image file group 50); acquiring area information which is information on an area related to the image data; selecting first image data (image data G1c in the example of FIG. 7) based on a first criterion from an image data group (image file group G1) which is a set of the image data corresponding to the same area information; and performing control of displaying, on a display (display 44), at least one image data (image data G1e and G1f in FIG. 7) in the image data group as second image data based on the first image data.

(29)

A display control program for causing a processor (processor 43) to execute steps comprising: acquiring a plurality of image data (acquired image file group 50); acquiring area information which is information on an area related to the image data; selecting first image data (image data G1c in the example of FIG. 7) based on a first criterion from an image data group (image file group G1) which is a set of the image data corresponding to the same area information; and performing control of displaying, on a display (display 44), at least one image data (image data G1e and G1f in FIG. 7) in the image data group as second image data based on the first image data.

Various embodiments have been described above, but the present invention is not limited to such examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2022-059048) filed on Mar. 31, 2022, the content of which is incorporated in the present application by reference.

### EXPLANATION OF REFERENCES

200: amusement facility
AR1, AR2, AR3: area
100: image management system
1a, 1b, 1c, 1: imaging apparatus
2: network
3: image storage server
4: image viewing device
40: display control device
41: communication interface
42: memory
43: processor
44A: first region
44B: second region
44C: third region
44D: fourth region
44E: fifth region
44R: display region
44: display
50A, 50: acquired image file group
g1, g2, g3: image file group
G1, G2, G3: image file group
51, 51x: image data
G1a to G1i: image data
G2a to G2c: image data
G3a to G3c: image data
MV1 to MV8: image data
MV: moving image data
441, 442, 443: area image

What is claimed is:

1. A display control device comprising:
a processor; and
a memory,
wherein the processor is configured to:
acquire a plurality of image data;
acquire area information which is information on an area related to the image data;
select first image data based on a first criterion from an image data group which is a set of the image data corresponding to the same area information; and
perform control of displaying, on a display, at least one image data in the image data group as second image data based on the first image data.

2. The display control device according to claim 1,
wherein the processor is configured to select third image data based on a second criterion from the plurality of image data, and
the image data group is a set of the third image data corresponding to the same area information.

3. The display control device according to claim 1,
wherein the processor is configured to select the second image data based on a capturing time point of the first image data.

4. The display control device according to claim 1,
wherein the processor is configured to select at least one of the image data captured before a capturing time point of the first image data or the image data captured after the capturing time point of the first image data as the second image data.

5. The display control device according to claim 4,
wherein the processor is configured to select the image data captured at a first time point before the capturing time point of the first image data and the image data captured at a second time point before the first time point as the second image data.

6. The display control device according to claim 1,
wherein the processor is configured to select the image data captured on a day different from a day including a capturing time point of the first image data as the second image data.

7. The display control device according to claim 1,
wherein the processor is configured to select the second image data based on a subject included in the first image data.

8. The display control device according to claim 1,
wherein the processor is configured to select the second image data based on a state of a subject included in the first image data.

9. The display control device according to claim 1,
wherein the processor is configured to select the second image data based on a state of a person among subjects included in the first image data.

10. The display control device according to claim 1,
wherein the processor is configured to select the second image data based on a state of an object other than a person among subjects included in the first image data.

11. The display control device according to claim 1,
wherein the processor is configured to select the second image data based on a numerical value related to a subject included in the first image data.

12. The display control device according to claim 1,
wherein the processor is configured to select the image data including the same number of subjects as the number of subjects included in the first image data as the second image data.

13. The display control device according to claim 1,
wherein the processor is configured to select the image data including the number of subjects different from the number of subjects included in the first image data as the second image data.

14. The display control device according to claim 11,
wherein the plurality of image data are generated by an imaging apparatus, and
the processor is configured to perform control such that the imaging apparatus generates image data including subjects whose number is based on the number of subjects included in the first image data, based on the number of the subjects included in the first image data.

15. The display control device according to claim 1,
wherein the processor is configured to select the second image data based on a position of a subject included in the first image data.

16. The display control device according to claim 1,
wherein the processor is configured to select the image data including a subject of which a position is different from a position of a subject included in the first image data as the second image data.

17. The display control device according to claim 1,
wherein the plurality of image data are generated by a plurality of imaging apparatuses, and
the processor is configured to select the second image data based on an imaging apparatus that has captured the first image data.

18. The display control device according to claim 17,
wherein the processor is configured to select the image data captured by an imaging apparatus different from the imaging apparatus that has captured the first image data as the second image data.

19. The display control device according to claim 1,
wherein the plurality of image data include moving image data,
the processor is configured to select third image data based on a second criterion from the plurality of image data,
the image data group is a set of the third image data corresponding to the same area information, and
the processor is further configured to select, in a case where the third image data composing the moving image data is selected as the first image data, image data included in the moving image data as the second image data.

20. The display control device according to claim 19,
wherein the processor is configured to perform control of reproducing moving image data including the first image data and moving image data including the second image data.

21. The display control device according to claim 20,
wherein the processor is configured to perform control of reproducing a portion of the moving image data from a capturing time point of the second image data in a case where the second image data is selected, and reproducing the moving image data from a beginning in a case where the first image data is selected.

22. The display control device according to claim 1,
wherein the processor is configured to select third image data based on a second criterion from the plurality of image data,
the image data group is a set of the third image data corresponding to the same area information, and
the processor is configured to:
perform control of displaying, on the display, the first image data, the second image data, and the third image data included in any of a plurality of the image data groups corresponding to different pieces of the area information; and
perform control of making a difference in the number of the third image data displayed on the display equal to or less than a threshold value for each image data group.

23. The display control device according to claim 1,
wherein the processor is configured to select third image data based on a second criterion from the plurality of image data,
the image data group is a set of the third image data corresponding to the same area information, and
the processor is configured to perform control of making a difference equal to or less than a threshold value, the difference being a difference between the number of the third image data included in the image data group corresponding to first area information and the number of the third image data included in the image data group corresponding to second area information.

24. The display control device according to claim 23,
wherein the processor is configured to:
select the third image data based on a third criterion from the image data group corresponding to the first area information;
select the third image data based on a fourth criterion from the image data group corresponding to the second area information; and
perform control of making the difference equal to or less than the threshold value by changing one or both of the third criterion and the fourth criterion.

25. The display control device according to claim 1,
wherein the processor is configured to perform control of displaying the first image data on the display.

26. A display control device comprising:
a processor; and
a memory,
wherein the processor is configured to:
acquire a plurality of image data;
perform control of displaying first image data among the plurality of image data on a display; and
perform control of displaying at least one image data among the plurality of image data as second image data on the display based on a state of a subject included in the first image data.

27. An image file management device comprising:
a processor; and
a memory,
wherein the processor is configured to:
acquire a plurality of image files;
acquire area information which is information on an area related to the image files; and
perform control of classifying the plurality of image files based on the area information.

28. A display control method comprising:
acquiring a plurality of image data;
acquiring area information which is information on an area related to the image data;
selecting first image data based on a first criterion from an image data group which is a set of the image data corresponding to the same area information; and
performing control of displaying, on a display, at least one image data in the image data group as second image data based on the first image data.

29. A non-transitory computer-readable storage medium that stores a display control program for causing a processor to execute steps comprising:
acquiring a plurality of image data;
acquiring area information which is information on an area related to the image data;
selecting first image data based on a first criterion from an image data group which is a set of the image data corresponding to the same area information; and
performing control of displaying, on a display, at least one image data in the image data group as second image data based on the first image data.
